(19) United States
(12) Patent Application Publication
(10) Pub. No.: US 2012/0254058 A1
(43) Pub. Date: Oct. 4, 2012

(54) ASSOCIATIVE TRACKING FOR LOOSELY-COUPLED SUPPLY CHAIN NETWORKS

(76) Inventors: Randy M. Walker, Knoxville, TN (US); Bryan L. Gorman, Knoxville, TN (US); David R. Resseguie, Knoxville, TN (US); Mallikarjun Shankar, Knoxville, TN (US)

(21) Appl. No.: 13/415,416

(22) Filed: Mar. 8, 2012

Related U.S. Application Data
(60) Provisional application No. 61/451,110, filed on Mar. 9, 2011.

(51) Int. Cl. G06Q 10/08; G06Q 50/28

(52) U.S. Cl. 705/333

(57) ABSTRACT

A resource tracking system for loosely coupled networks may utilize tags for tracking across multiple proprietary asset management systems. A shipment may be assigned a unique identifier, which is associated with any tags for that shipment. The tags may be from any entity in a supply chain and the tagged information may be available over a network for real-time tracking at any point in a supply chain.

### PRIORITY CLAIM

This application claims priority to Provisional Pat. App. No. 61/451,110, filed on Mar. 9, 2010, the entire disclosure of which is hereby incorporated by reference.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### TECHNICAL FIELD

The present description relates generally to a system and method, generally referred to as a system, for tracking resources in a loosely-coupled network and for tracking a supply chain in a loosely-coupled network.

### BACKGROUND

There are manual and automated systems for tracking items through the supply chain. The difference between the existing state of the art and the present example of a web-based system for associative tracking in a loosely-coupled supply chain network is that the latter provides the means by which the former systems, regardless of their compatibility, can share tracking information end-to-end. In certain supply chains, such as the transportation of hazardous materials, there may be lacking common framework in which shippers, receivers, and stakeholders can interface. Most of the information in these supply chains may exist in numerous proprietary, agency-centric, or contractor systems. The information may be essentially trapped within the disparate systems throughout the supply chain.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a loosely-coupled supply chain network.

FIG. 2 is block diagram of a general overview of a resource tracking system for the loosely-coupled supply chain network of FIG. 1 or other loosely-coupled networks.

FIG. 3 is a block diagram of a network environment implementing the resource tracking system of FIG. 2, or other resource tracking systems for loosely-coupled networks.

FIG. 4 is a block diagram of transportation stages of the loosely coupled supply chain network of FIG. 1 or other loosely coupled supply chain networks.

FIG. 5 is a flowchart illustrating the operations of the resource tracking systems of FIG. 2 and FIG. 3, or other resource tracking systems for loosely-coupled networks.

FIG. 6 is a flowchart illustrating the operations of a tag based resource identifier lookup in the systems of FIG. 2 and FIG. 3, or other resource tracking systems for loosely-coupled networks.

FIG. 7 is a flowchart illustrating the operations of writing a tag to a resource identifier in the systems of FIG. 2 and FIG. 3, or other resource tracking systems for loosely-coupled networks.

FIG. 8 is an illustration of exemplary tag associations for a resource identifier in the systems of FIG. 2 and FIG. 3, or resource tracking systems for loosely-coupled networks.

FIG. 9 is a screenshot of an interface for viewing tag data associated with a resource identifier in the systems of FIG. 2 and FIG. 3, or other resource tracking systems for loosely-coupled networks.

FIG. 10 is an illustration of a general computer system that may be used in the systems of FIG. 2 and FIG. 3, or other resource tracking systems for loosely-coupled networks.

### DETAILED DESCRIPTION

The disclosed embodiments relate to tracking resources in a loosely-coupled network, and more particularly, but not exclusively, to tracking a supply chain in a loosely-coupled network. The present embodiments provide the means by which the loosely-coupled, incompatible supply chain management systems can share tracking information end-to-end. A secure portal is accessible by all supply chain partners with strong authentication that identifies them as a stakeholder. Each shipment is assigned a permanent and unique ID to track it through the supply chain. Each step of the transfer, inspection and regulatory review of the shipment is available through the portal by accessing the unique ID. For illustrative purposes the principles described herein may be referenced in the specific embodiment of a supply chain; however the principles may be embodied in many different forms.

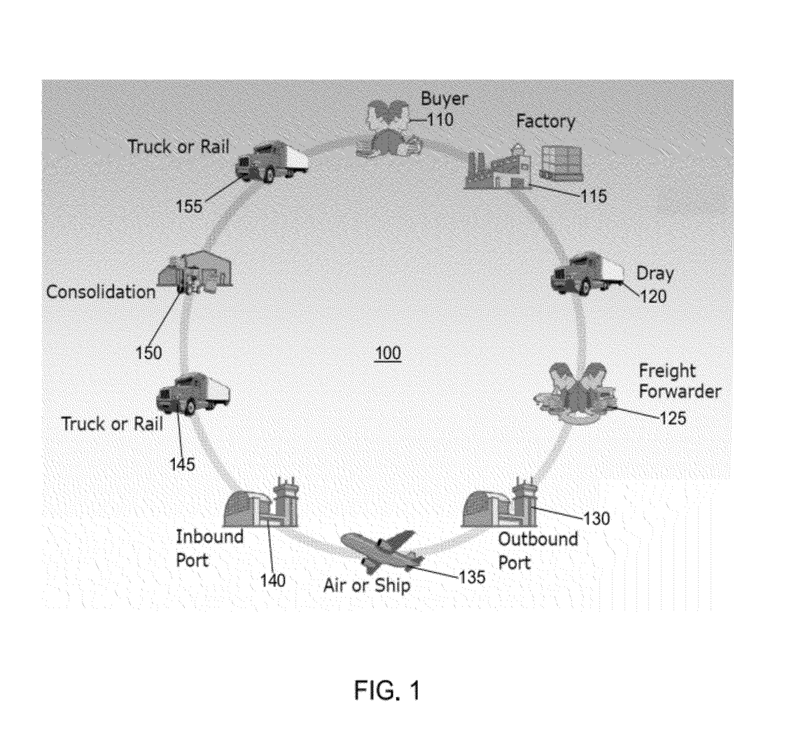

FIG. 1 provides a general overview of a loosely-coupled supply chain network. Not all of the depicted components may be required, however, and some implementations may include additional components. Variations in the arrangement and type of the components may be made without departing from the spirit or scope of the claims as set forth herein. Additional, different or fewer components may be provided.

FIG. 1 illustrates a supply chain 100 from the buyer 110. A factory 115 produces a product that is shipped with a dray 120. A freight forwarder 125 transports freight. An outbound port 130 may have the product sent by air or ship 135 to an inbound port 140. Truck or rail 145 can then transport to consolidation 150 where track or rail 155 deliver to the buyer 110. The exemplary supply chain network illustrates multiple nodes through which a product may pass. Multiple nodes may result in potential disruptions, so risk management may be greater.

As described, the illustrated supply chain may include next generation tracking capabilities including social networking or Web 2.0 capabilities to improve tracking throughout the supply chain. Web 2.0 may refer to recent and ongoing innovations that facilitate communication, information sharing, interoperability, and collaboration. For example, these web innovations may include social-networking sites, video-sharing sites, wikis, blogs, or other information sharing. Social networking sites at their technology core include an internet connection, a Web address, a search engine, and a wiki-engine. Their purpose and popularity originates from their ability to allow people of like interest to meet, share, learn and talk with the touch of a button.

The described tracking system includes modeling and visualizing underlying system design of the supply chain in FIG. 1. Integrated smart sensors may be used for tracking with smart systems pilots for high risk commodity supply chains. Exemplary high risk commodities include weapons, nuclear, flammable, or hazardous materials. The Nuclear Regulatory Commission issued the National Source Tracking System rule codified in Title 10 Parts 20 and 32 of the Code of Federal Regulations that established a list of twenty radioisotopes defined as Nationally Tracked Sources (NTS) and mandated security measures to be taken by licensees during manufacture, storage, transport, receipt and disassembly. Different systems and regulatory agencies oversee the transportiton of high risk commodities. Standardized product codes such as Uniform Product Codes or Electronic Product Codes do not exist that integrate the high risk supply chain product manufacturers/users with the transporters. In other words, most of the information needed by supply chain partners already exists but is trapped in proprietary or “stove piped” databases.

An interoperable process for communicating throughout the supply chain may incorporate Web 2.0 concepts (e.g. social networking features) as part of the supply chain backbone as a way for combining multiple legacy tracking systems. This communications backbone may be referred to as LogisPedia. Sensor information in the supply chain that is used for tracking can be shared throughout the nodes in the supply chain. The increased visibility may result in increased reliability.

Loosely-coupled, incompatible supply chain management systems may share tracking information end-to-end. This system may be referred to as “Tracking 2.0.” A secure portal is accessible by all supply chain partners with strong authentication that identifies them as a stakeholder. Each shipment is assigned a permanent and unique ID to track it through the supply chain 100. Each step of the transfer, inspection and regulatory review of the shipment is available through the portal by accessing the unique ID. The system can share tracking information end-to-end even with older tracking system by interfacing through a heterogeneous “social network” of tracking systems.

As described, the shipping and transportation needs that are met by the tracking system as well as shipping characteristics that the system is designed to handle may include importation, differing modes of transport, private/contract/public/hired carriage, special carrier handling/segregation, physical/chemical characterization, packaging requirements, world-wide regulations, emergency response concerns, and security concerns. There may a desire to support shipment material real time tracking which would provide obvious advantages to satisfying security and emergency response concerns including those shipments that are made for hazardous waste and substances. Hazardous shipments also have the property of requiring multiple shipping documents and substantial data. Several electronic databases applicable to hazardous materials exist and may be included in the tracking system, including multiple regulatory agencies (i.e. DOT, NRC, EPA, States, international jurisdictions, etc.).

The system may streamline the process of identifying and collating transport lost, astray, damaged and opened shipments (e.g., streamlining insurance claims) and the various contractual legal shipping documents that are required. Indeed, there is a significant gap between what exists in terms of standard operational procedures and what is possible given the array of commercial off the shelf technology (COTS) that exists to address the DOE EM objectives and national needs. In the example of hazardous waste, the tracking system may be naturally distributed, automatically updated, secure, and provides real-time visibility of that sector of the environmental management waste packaging, transportation and disposal chain. The protocols and artifacts that make up the tracking system are contextually extensible across all domains of the chain illustrated in FIG. 1.

There exist current data systems with asset visibility, but not necessarily a way to connect the data. For example, the Department of Energy (“DOE”) has total asset visibility and exceptions-based environmental management (“EM”) reporting through numerous proprietary, agency-centric, contractor or DOE data systems. ME waste materials may include hazardous, radioactive, or otherwise sensitive material. A collective technological solution for end-to-end DOE EM, packaging, transportation and disposal, is possible if the “trapped” information in these legacy systems can be joined as part of a common timeline with a common spatial reference. Establishing a defined and bounded information “system of systems” for DOE EM may not be a cost effective or realistic solution for EM activities. A virtual system of systems, preserves the existing legacy applications and links them into a loosely-coupled network of systems. The “virtual system of system” is further described below and may be referred to generally as the tracking system. The tracking system may link multiple legacy applications and system based on interfaces associated with the concept referred to as “Web 2.0.” Web 2.0 applications include a broad range of social networking sites, content-sharing sites, wikis, blogs, and mash-ups that facilitate interoperability and collaboration on the World Wide Web. These same concepts can be applied to establish near real-time, end-to-end transparency across loosely-coupled EM systems. Such an EM solution adapts Web 2.0 information sharing technologies to link incompatible, autonomous, or proprietary systems with minimal impact on existing processes and procedures. The sharing of technology and information by the tracking system through Web 2.0 concepts may also be referred to as Tracking 2.0.

The system may include the following components: 1) the assignment of a permanent and unique web address or Uniform Resource Locator (URL) to track a unique EM element; 2) a secure portal with “social networking” capabilities to connect the various EM stakeholders and their applications with each other; and 3) the ability to dynamically incorporate and associate searchable user-defined tags to the EM element's URL. These tags may be assigned incrementally to the URL by the various systems that monitor the linked element at different times and provide the means to “find” the element through independent searches on any of the tags. The tags for each element creates a “tagsonomy” or “folksonomy” which permits a single element to be located by searches for any of the tags that are unique to each of the different systems that tracks it (i.e., where relationships or associations exist). The system may also include the following components: 4) the use of geotags to enable all elements a way to be geo-referenced and combined to present a spatial “mashup” of its locations over time (i.e., where and how was the element transported); and 5) the use of Web 2.0 publish and subscribe standards (e.g., Really Simple Syndication—RSS and The Atom Syndication Format) to link data feeds to social networks.

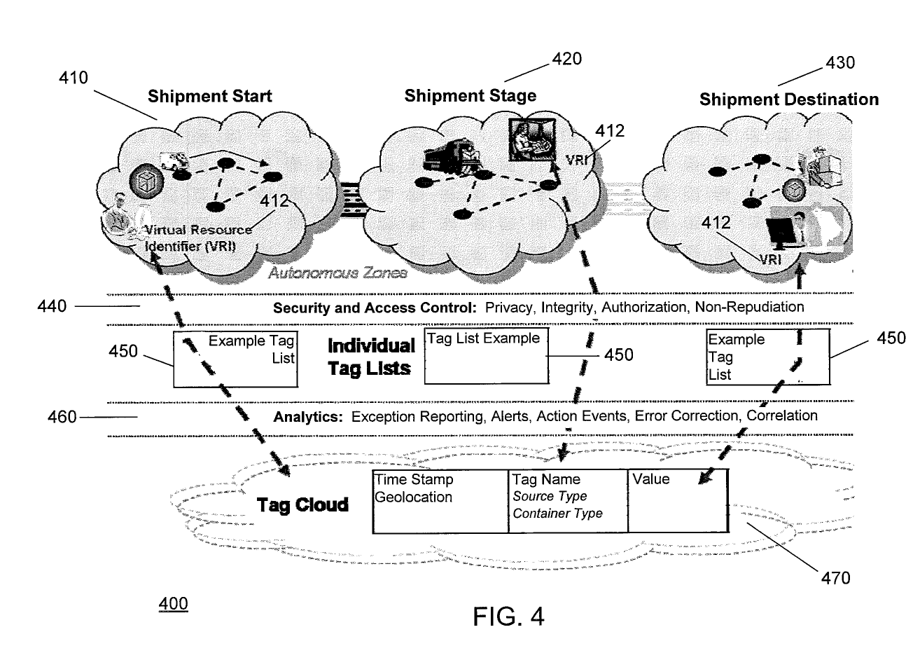

A tag may be a label that is used to help locate and organize data (e.g. photographs, video, observations, and websites). A user-defined tag may be any information that each user contributes to describe an item. The tags allow the item to be found by the web site's search engine. Tags may be any information assigned to the shipped item by any of the partners in the supply chain. For example, tags associated to an item's unique URL may be an enterprise's tracking number or the shipment's serial number. The tags may further be described below with respect to FIGS. 4-9.

In the commercial sector, proprietary tracking systems may use multi-sensor technologies that are integrated at the transporter level. Examples of tracking technologies used in proprietary tracking systems include: 1) barcode (at the package level); 2) satellite (common at the power unit level); 3) RFID (common at the transport equipment level); and 4) cellular (common at the personnel level). Each of these tracking systems may generate a tag that is associated with tracked resource.

A secured web 2.0 portal may be used to assign a permanent unique tag to a source encoded as a web address which may allow authenticated supply chain partners to 1) “add” their data to the “bucket” using legacy commercial and government information and tracking systems; 2) use partial pieces of information to achieve shipment visibility; and, 3) deploy a low-cost and quick-to-market solution that merges popular, proven and intuitive web 2.0 social networking technologies with emerging cyber security enhancements to provide secured visibility of a source's product lifecycle.

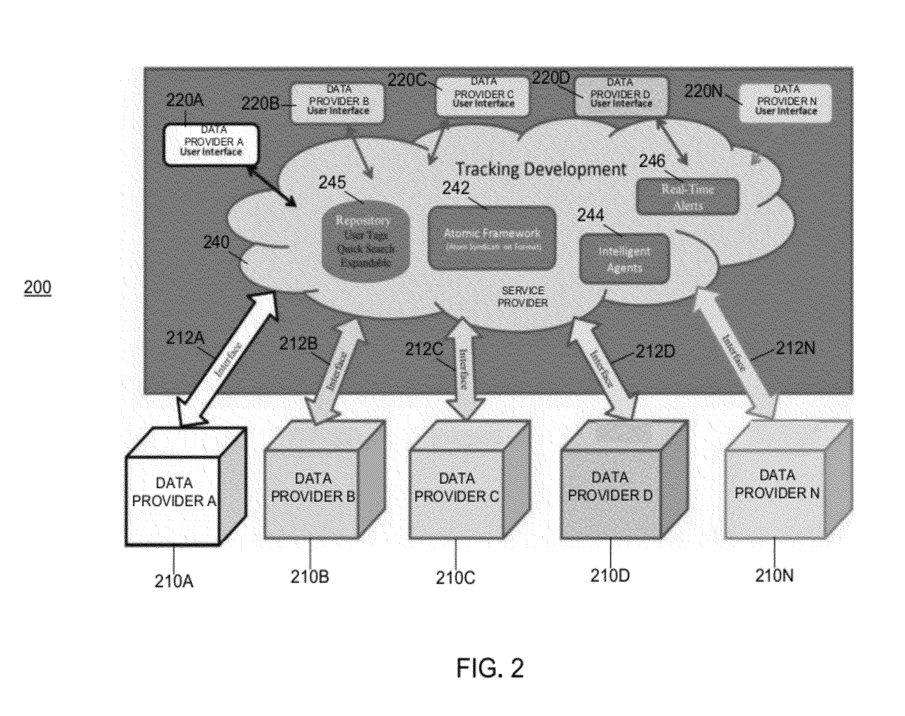

FIG. 2 is block diagram of a general overview of a resource tracking system for the loosely-coupled supply chain network of FIG. 1 or other loosely-coupled networks. Not all of the depicted components may be required, however, and some implementations may include additional components not shown in the figure. Variations in the arrangement and type of the components may be made without departing from the spirit or scope of the claims as set forth herein. Additionally, different or fewer components may be provided.

The linkage of five separate DOE internal systems may be used as an exemplary embodiment for the tracking described herein. In one example, there may be a need to inquire into exposure to radioactive and/or hazardous substances. To respond to such inquiries, a systems manager must access information from a number of independent, internal systems. The tracking system may be useful in supporting their responses to such inquiries. Not only would it track link exposure to radioactive and hazardous materials, but it would also provide visibility into the tracking of materials from procurement to disposal.

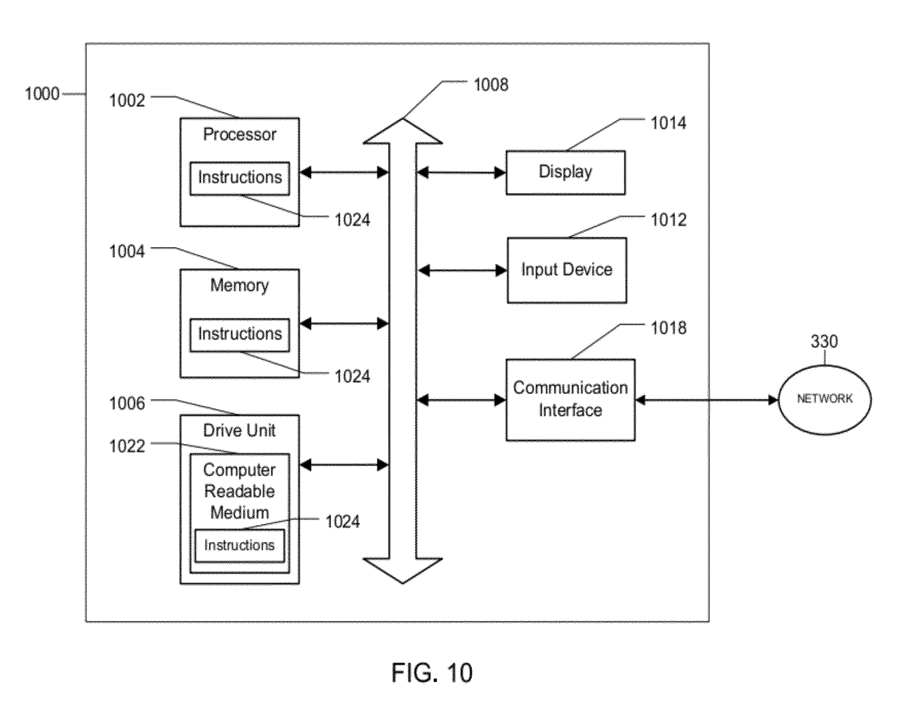

A “mashup” or aggregate information from five different and independent systems or data providers (Data Provider A-N, 210A-N) may be used to compile data. A mashup combines data from two or more sources into a single integrated view. The tracking development cloud 240 will include networked data and may be referred to as the tracking cloud. Each of the data providers A-N, 210A-N may be coupled with the tracking cloud 240 through individual interfaces 212A-N, respectively. Outside of the physical location of each of the data providers A-N, 210A-N are data provider user interfaces A-N, 220A-N which allow access to the tracking cloud 240 through a network (e.g. the network described with respect to FIG. 10). The tracking cloud 240 represents a network based repository of information that is accessible over the network. In one embodiment, the network is the Internet and the user interfaces A-N, 220A-N which allow access to the tracking cloud 240 are web browsers or other software/computers for accessing the Internet.

The tracking cloud 240 may include a repository 245 or database that includes user tags along with search functionality. The user tags including virtual resource identifiers stored in the tracking cloud 240 will be further described with respect to FIG. 4. In one embodiment, the tracking cloud may include an atomic framework 242, intelligent agents 244, and real-time alerts 246.

For the DOE example, the Radioactive Materials Information System (RMIS), the Hazardous Materials Management Information System (HMMIS), the Environmental Management Waste System (emWaste or BROADpointe), the Bechtel Jacobs RFID System (EMWMF), and the Bechtel Jacobs Waste Transportation Management System (WTMS) may be used as exemplary data providers and may correspond to the Data Providers A-N 210A-N. This integrated technological solution may require universal digitization of DOE EM information via the emerging social media and collective intelligence technologies of the Semantic Web. The path forward proposal starts with a DOE real world offsite demonstration project for the tracking of RAM in the waste packaging, transportation and disposal chain.

The tracking system may create a “secure honest broker” data clearinghouse prototype. A universal shipment tagging prototype may be used for tagging. Inherited information databases may be used as a baseline. The system may track the shipments using remote tracking technology(s). The tagged data may be received and distributed using a Tracking 2.0 prototype. A secure social networking engine based on electronic shipping data tagging may be used with the tags. Automated exceptions reporting and a query-enabled and knowledge-sharing search engine may be part of the system. The establishment of a universal naming convention across multiple, incompatible enterprise systems may be used for the tagging system and for integrating information from emerging tracking technologies and legacy tracking systems, as well as exploiting legacy commercial and federal databases to reveal query-driven information requests in real time.

FIG. 2 illustrates the bridging and aggregating elements necessary to combine relevant functionalities. For the above mentioned exemplary data providers, the system provides information on the trucks carrying material from demolished builds at the K-25 and ORNL sites to the EMWMF waste facility on the Oak Ridge reservation. The EMWMF system uses RFID tags attached to dump trucks to track their location. The WTMS processes information related to the waste characterization of the load being carried by the truck along with the truck weight and transportation parameters such as transit times to and from the waste facility. These transportation parameters are utilized by the waste facility operators to optimize productivity of the waste shipments and waste facility utilization. The WTMS system provides the electronic shipping papers required for each shipment of waste from the demolition site to the waste facility.

An exemplary data provider may be a weigh-in scale. Basic waste characterization data may be written onto an RFID tag before a truck left the demolition site. The truck then passes over the scales where it is weighed and the weight information is process via the electronics in the yellow tower to the WTMS. The truck then travels to the EMWMF waste site where the debris is unloaded and placed into the waste facility. The dump location is then written to the RFID tag and the truck returns for another waste load. RIFD reader/writers at or close to the demolition site and the waste facility provide truck location and transit times to the system. Once the truck is weighed, the waste characterization data and truck information, including weight, is transmitted to the WTMS system where the electronic shipping papers for that shipment are produced. The system (e.g. tracking cloud 240) links the data from five of the systems to display the mashup of either the EMWMF and WTMS systems or the RMIS, HMMIS, and emWaste systems. The system aggregates the data from the EMWMF RFID system and WTMS system into a display which allows oversight into the waste shipment process.

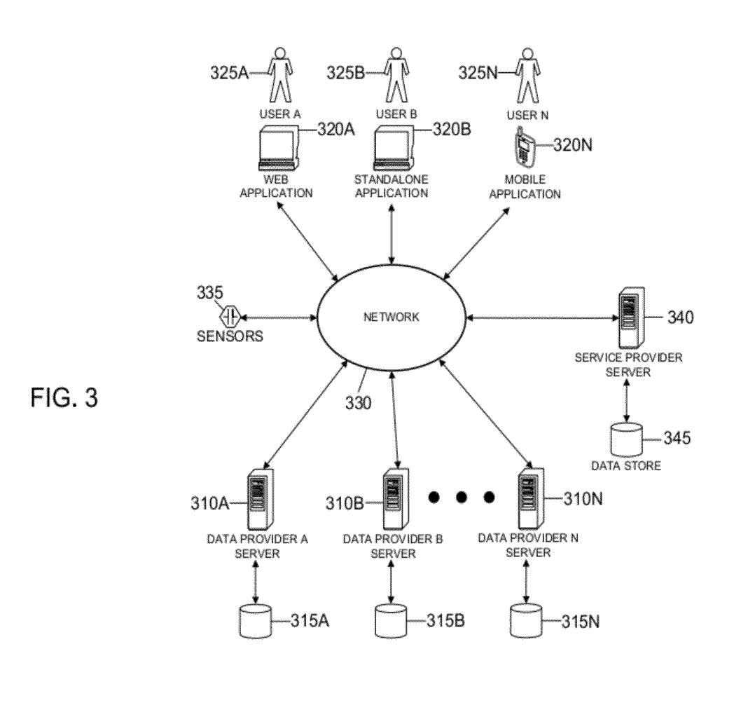

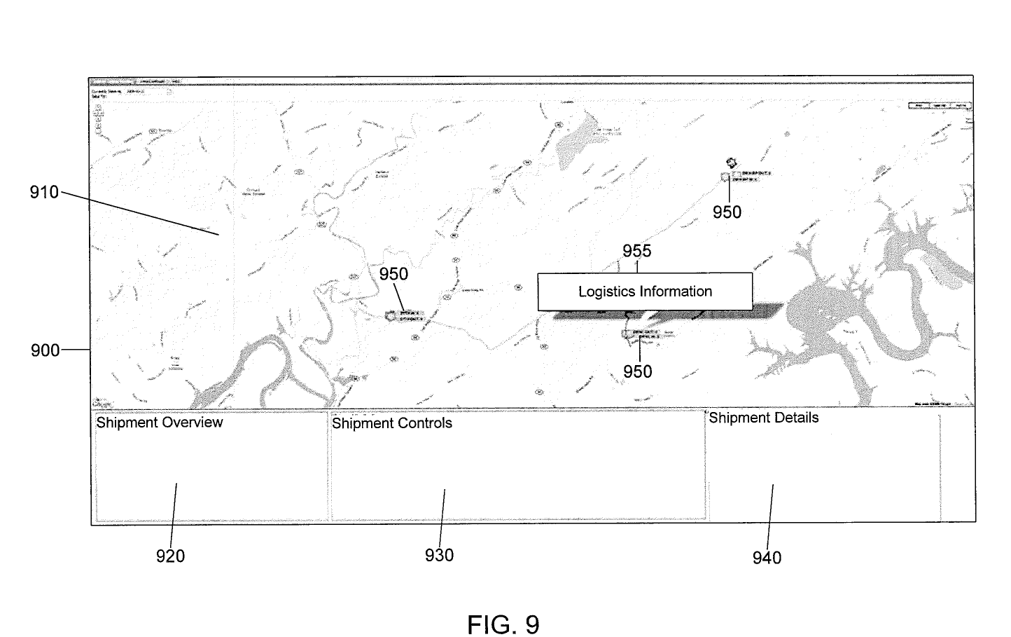

FIG. 9 is a screenshot of a display or an interface 900 for viewing tag data associated with a resource identifier in the systems of FIG. 2 and FIG. 3, or other resource tracking systems for loosely-coupled networks. In particular, FIG. 9 may be a EMWMF shipment display 900 of the system which depicts how a rapid overview assessment of the status of the shipments. In one embodiment, the shipment display 900 may be part of the website or software that the user interfaces A-N, 220A-N utilize for accessing the tracking cloud 240. The information displayed on the shipment display 900 may be information stored in the tracking cloud 240.

The display 900 includes a map 910 illustrating locations. In particular, locations 950 are shipments in route. The locations 950 may be “hotlinks” which, when clicked, display additional logistics information 955 such as transit and residence times for the shipments in a “bubble” so that work flow can be maintained and monitored. Within this bubble, there may be an additional “hotlink” for each shipment which, when clicked, displays pertinent shipment information in the three boxes at the bottom of the screen. There are additional hotlinks within these shipment information boxes which allow the user to seamlessly merge the data from the EMWMF RFID system with the electronic shipment papers created by the WTMS system. Additionally, there may be a link for first responder use, which presents the applicable portions of an emergency response guide for the materials contained within the selected shipment.

The display 900 includes a shipment overview 920, shipment controls 930, and shipment details 940. The shipment overview 920 may include an overview of major events from the shipment chain. The shipment controls 930 may include control details of the shipment chain. The shipment details 940 may include all details, features, and tags from the shipment chain.

FIG. 3 is a block diagram of a network environment implementing the resource tracking system of FIG. 2, or other resource tracking systems for loosely-coupled networks. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The network environment 300 may include one or more web applications, standalone applications, mobile applications which may run on computing devices 320A-N of the users 325A-N and a web application 320A, which may run on a computing device. The network environment 300 may also include a network 330, a sensor(s) 335, a service provider server 340, and a data store 345.

The data store 345 may be operative to store data, such as data from the users 325A-N. The data store 345 may include one or more relational databases or other data stores that may be managed using various known database management techniques, such as, for example, SQL and object-based techniques. Alternatively or in addition the data store 345 may be implemented using one or more of the magnetic, optical, solid state or tape drives. The data store 345 may be in communication with the service provider server 340.

The network 330 may include wide area networks (WAN), such as the internet, local area networks (LAN), campus area networks, metropolitan area networks, or any other networks that may allow for data communication. The network 330 may include the Internet. The network 330 may be divided into sub-networks. The sub-networks may allow access to all of the other components in the system 300. The network 335 may be regarded as a public or private network connection and may include, for example, a virtual private network or an encryption or other security mechanism employed over the public Internet, or the like.

In one embodiment, the tracking cloud 240 may be located in the network 330 and may be accessible by any of the users and/or data providers. An administrator may communicate with the service provider server 340 via the network 330. The administrator may use a graphical interface provided by the service provider server 340 to maintain and/or modify information relating to the auctions provided by the service provider server 340. The graphical interface may run on a computing device. The service provider server 340 may communicate with the users 325A-N via the network 330, through the web applications, standalone applications or mobile applications running on the computing devices. The users 325A-N may access interfaces for participating in bid invalidating auctions from the service provider server 340 through computing devices 320A-N that may be running a web application that may be on any platform that supports web content, such as a web browser or a computer, a mobile phone, smartphone, tablet, personal digital assistant (PDA), pager, network-enabled television, digital video recorder, such as TIVO®, video game console/device, automobile and/or any appliance or device capable of data communications.

The computing device may run a standalone application may be a machine that has a processor, memory, a display, a user interface and a communication interface. The processor may be operatively connected to the memory, display and the interfaces and may perform tasks at the request of the standalone application or the underlying operating system. The memory may be capable of storing data. The display may be operatively connected to the memory and the processor and may be capable of displaying information to the user B 325B. The user interface may be operatively connected to the memory, the processor, and the display and may be capable of interacting with a user B 325B. The communication interface may be operatively connected to the memory, and the processor, and may be capable of communicating through the network 330 with the content provider server 340. The standalone application 320B may be programmed in any programming language that supports communication protocols. These languages may include: SUN JAVA®, C++, C#, ASP, SUN JAVASCRIPT®, asynchronous SUN JAVASCRIPT®, or ADOBE FLASH ACTIONSCRIPT®, amongst others.

The computing device 320N running a mobile application may be any mobile device that has a data connection. The data connection may be a cellular connection, a wireless data connection, an internet connection, an infra-red connection, a Bluetooth connection, or any other connection capable of transmitting data. For example, the mobile application may be an application running on an iPhone™ available from Apple, Inc.

The service provider server 340 may include one or more of the following: an application server, a data store, such as the data store 345, a database server, a middleware server, and an advertising services server. The service provider server 340 may exist on one machine or may be running in a distributed configuration on one or more machines The service provider server 340 may be referred to as the server. The service provider server 340 and the data provider servers 310A-N may receive communications from the users 325A-N, such as HTTP requests, and may serve pages to the users 325A-N based on their communications.

The service provider server 340, the computing devices 320A-N and the data provider servers 310A-N may be one or more computing devices of various kinds, such as the computing device described in FIG. 10 below. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite.

There may be several configurations of database servers, such as the data store 345, application servers, middleware servers and advertising services servers included in the service provider server 340. The data provider servers may be connected with such a database 315A-N, respectively. Database servers may include MICROSOFT SQL SERVER®, ORACLE®, IBM DB2® or any other database software, relational or otherwise. The application server may be APACHE TOMCAT®, MICROSOFT ITS®, ADOBE COLDFUSION®, YAPACHE® or any other application server that supports communication protocols. The middleware server may be any middleware that connects software components or applications. The middleware server may be a relevancy engine, a context matching engine, or any other middleware.

The network 330 may be configured to couple one computing device to another computing device to enable communication of data between the devices. The network 330 may generally be enabled to employ any form of machine-readable media for communicating information from one device to another. The network 330 may include one or more of a wireless network, a wired network, a local area network (LAN), a wide area network (WAN), a direct connection such as through a Universal Serial Bus (USB) port, and the like, and may include the set of interconnected networks that make up the Internet. The network 330 may include any communication method by which information may travel between computing devices.

The system may utilize two basic software components: 1) a secure web 2.0 portal with “social networking” capabilities to connect the various supply chain stakeholders with each other and to assign a permanent and unique virtual resource identifier (VRI), encoded as a unique web address or Uniform Resource Locator (URL), to track a unique shipment; and 2) the ability to associate searchable user-defined tags to the VRI. These tags may be assigned by the various partners involved in the shipment.

The VRI may logged in a central database/clearing house/authority and may be initially tagged with data regarding the originator, product type, etc., and may automatically add attributes to incoming tags such as date, source IP address, geo tag, etc. The VRI database may be distributed with a singular interface which can query the distributed data stores. At each interchange, handler/stakeholder may be responsible for providing additional tags to the VRI. Shippers may tag with their tracking code, or require their sub contractors to tag. Auto feed additional tag information may be sent to the central repository from tracking systems. The VRI database provides a mechanism for obtaining all tags for the VRI or searching tags. The VRI database provides for authenticated access and alerts. For example, when no tag entered for a VRI over certain time period, an alert may be sent to relevant parties, such as the originator of the VRI. Other alert examples include when a discontinuity in tags is detected; when duplicative tag is entered; or when changes occur. The database may be an associative database rather than a relational database. Each tag/data item may only be associated with the VRI. The VRI database may be accessible over a network, and the VRI data (including tags) stored in the database may generally be referred to as data “in the cloud” since it is accessible over a network.

The VRI database or tag storage may be an associative array. An associative array (also referred to as associative container, map, mapping, dictionary, finite map, and in query-processing an index or index file) may an abstract data type composed of a collection of unique keys and a collection of values, where each key is associated with one value (or set of values). The operation of finding the value associated with a key is called a lookup or indexing. The relationship between a key and its value is sometimes referred to as a mapping or binding. In one embodiment, a tag may be permanent, and once it is entered it cannot be changed, but additional tags may be added. A tag may be used to both find records in the system and to label pointers to other enterprise tracking systems. Participants may still maintain their own systems and provide an identifier, link or pointer as a tag to the VRI. Tags not only characterize the VRI but also provide a link to other resources (like the shipper databases).

FIG. 4 is a block diagram of transportation stages of the loosely coupled supply chain network of FIG. 1 or other loosely coupled supply chain networks. FIG. 4 illustrates an exemplary technical solution architecture. At the starting point 410 of a shipment, the package is registered and assigned a Virtual Resource Identifier (VRI) 412. The VRI is a unique identifier that can be references throughout the supply chain, including the shipment stage 420 and the shipment destination 430. There may be security and access control 440 at all stages of the supply chain. For example, at certain stages, the information provided may have restricted access. At each of the illustrated stages 410, 420, 430, there may be an individual tag list 450 associated with the VRI 412. The tag list may include information that is tagged to the VRI along the chain. In one embodiment, there may be an individual tag list 450 for each of the stages. Based on the tag lists 450, there may be analytics 460 performed on the information. The analytics 460 may include exception reporting, alerts, action events, error correction, and/or correlation. The analytics may identify other relationships that are evident/discernible via queries. Tag clouds of data items may only make sense when interpreted (sorted, arranged, etc.) and analyzed collectively since generically, a tag is a concept/data record providing some sort of information about the item. The analyzed 460 information and information from the individual tag lists 450 may be part of the tag cloud 470. The tag cloud 470 may be the tracking cloud 240 from FIG. 2 and may include information (e.g. tagged information) that is available over a network, such as the Internet.

By allowing an identifier to be created dynamically, the system becomes agnostic to origin—by region, by sector, by mode, by owner, and by regulation. Individual shippers (or partners in autonomous zones) may add tag information to the package associating it with the VRI. This information is access controlled using well established security mechanisms. By allowing incremental tags to be associated with the shipment, the system becomes resilient and flexible to transfers between carriers and institutions, and at the same time can tolerate incorrect, partial, or faulty information. Individual users can look up the shipment or track it based purely on the tag information they have associated with the VRI, and they can retrieve and view the location of the shipment based on that tag information. Using access control and permissions, a shipper or transporter can allow or limit users from viewing proprietary information associated with the shipment. Importantly, if the VRI is lost, or if incorrect information is entered, an analytical search layer can retrieve the correct shipment based on “partial” information alone. The searchable association mechanism allows all steps in the supply chain to “get to what they want” for identification and visibility purposes.

The use of tags over a network such as the tracking cloud 240 or tag cloud 470 may be used by government and industrial partners with a VRI for adding information about a particular shipment/product. The tag may be a location (geo-tag) or other information about the shipment that is tagged to the VRI in the tracking cloud 240, which is accessible throughout the supply chain. In one embodiment, each of the entities 110-155 from FIG. 1, or users 325 or data providers 310 from FIG. 3, can access the information stored in the tracking cloud 240. In other embodiments, certain information is available to certain entities. For example, locations for nuclear device shipments may be locked down to most entities in the supply chain.

The process for establishing a system for tracking an item end-to-end through loosely-coupled supply chains may include: 1) establishing a social network web site for supply chain partners; 2) registering supply chain partners with strong authentication that identifies them as manufacturers, fabricators, end users, transporters, disposal facilities, Government users, etc.; 3) when entering an item into the supply chain, the registered user will be assigned a permanent, unique network link or Uniform Resource Locator (URL) by the tracking web site that is associated with the item throughout all of the supply chain; 4) the URL may be shared, with user-defined read-write-search permissions, among all partners involved in the supply chain shipment; 5) on the URL interface, each partner's enterprise tracking information may be associated with the URL as user-defined “tags”; 6) supply chain partners will login and distribute and receive data about the shipped item with their current enterprise applications and tracking systems, using the URL when they want to link their enterprise information with another partner's system. Any unique enterprise tracking number, shipper's UPC/EPC, transporter's tracking code, or any identifying document can be uploaded, referenced, or linked to the URL as a tag or reference to the tracked item.

The process for establishing a system for tracking an item end-to-end through loosely-coupled supply chains may further include: 7) if authorized, supply chain partners can query the system with any number of parameters, keywords, names, etc. Queries can also be spatial. Because each partner's tags may associated with the shipment's unique and permanent URL, searches on the interface can locate the shipment record by any of the “tags” associated with the URL.

The process may further include: 8) at any supply chain transfer point, the URL can be accessed to re-tag the item with additional information from an authorized supply chain partner, while preserving previously written tags; 9) the URL can be accessed by authenticated supply chain partners who have the appropriate read/write permissions to determine any number of data, such as where the shipment is, a record of how the shipment has been transported, inspections conducted; whatever other previous information that is referenced by the unique and permanent URL; 10) when the shipment reaches its destination and is accepted, the receiver may electronically tag the shipment as completed; 11) the URL may be recorded in any supply chain partner's internal tracking system and a shipping history will be available at safetracking.org in the event of post-shipment inspection, questions or re-shipment; 12) the regulatory sector, with appropriate permissions, may have a “peer in” ability to find the history and current status of a shipment by searching for the tags provided by any of the supply chain partners; and 13) common Web 2.0 services such as mash-ups and blogs may be utilized to obtain instantaneous information and knowledge sharing.

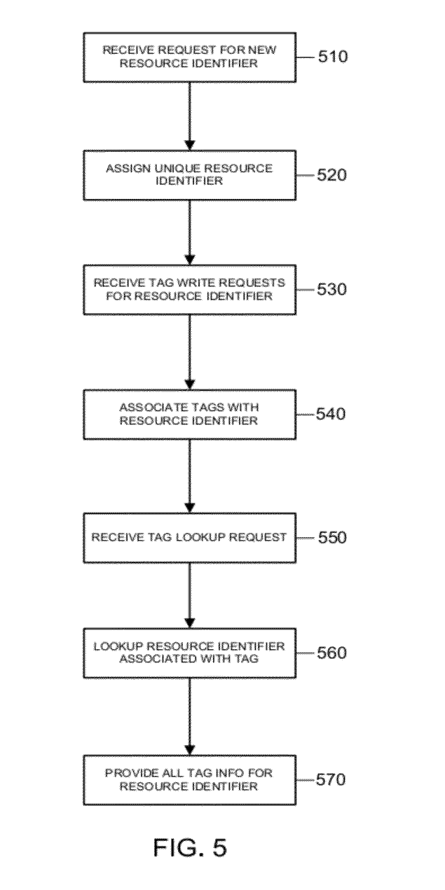

FIGS. 5-7 illustrate further operations for resource tracking. FIG. 5 is a flowchart illustrating the operations of the resource tracking systems of FIG. 2 and FIG. 3, or other resource tracking systems for loosely-coupled networks. The steps of FIG. 5 are described as being performed by the service provider server 340. However, the steps may be performed by the processor of the service provider server 340, or by any other hardware component of the service provider server 340. Alternatively the steps may be performed by an external hardware component.

In block 510, a request is received for a new resource identifier. When the request is received, a unique identifier is assigned in block 520, such as the VRI 412. The VRI 412 may be referred to as a unique resource identifier. In one example, the request may originate with at the beginning of the supply chain, such as at the shipment start 410. In block 530, tag write requests may be received for a particular VRI. At any point in the supply chain, participants in the chain and outside observers (subject to access restrictions) may request to add tags for a VRI. In block 540, the written tags are associated with the VRI.

The tags associated with a VRI may be available over a network with a tag cloud or tracking cloud. In block 550, a tag lookup request may be received. The request may be received over a network. In response to the request, a lookup is made of the VRI associated with the tag in block 560. The information associated with the tag or VRI may be provided in block 570. In other words, upon requesting information for a particular VRI, all tagged information for that VRI may be returned, subject to access restrictions. The tags for a VRI may available over a network, such that the tagged information is located in the cloud.

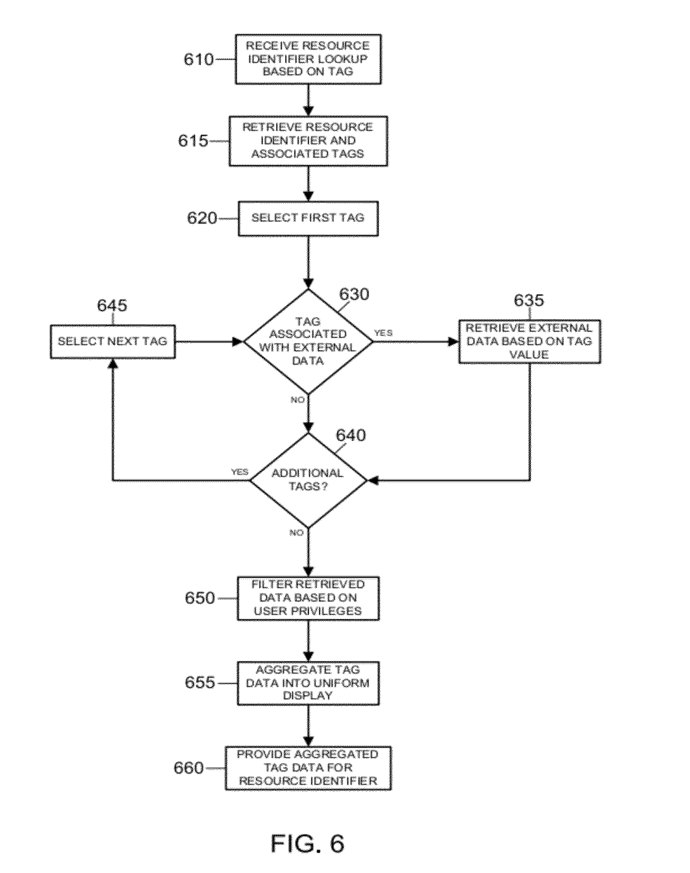

FIG. 6 is a flowchart illustrating the operations of a tag based resource identifier lookup in the systems of FIG. 2 and FIG. 3, or other resource tracking systems for loosely-coupled networks. The steps of FIG. 6 are described as being performed by the service provider server 340. However, the steps may be performed by the processor of the service provider server 340, or by any other hardware component of the service provider server 340. Alternatively the steps may be performed by an external hardware component.

In particular, FIG. 6 illustrates a request for tagged information that may include external data and that filters the tagged information. In block 610, a request for a resource identifier (e.g. VRI) lookup is received based on a tag. For example, a lookup request based on a tag may include a geographic or time tag, such as requesting a geographic location for a shipment. Geographic location is just one example of the type of information that may be tagged to a VRI. In block 615, the resource identifier or VRI is retrieved along with the tags associated with that identifier. The first tag for the VRI is selected in block 620. In block 630, a determination is made as to whether the tag is associated with external data. If the tag is associated with external data, the external data is retrieved based on the tag value in block 635. In block 640, if there are additional tags, the next tag is selected in block 645. Upon selection the next tag, a determination is made as to whether the tag is associated with external data. Once the external data has been retrieved for each additional tag, the information is filtered based on user privileges in block 650. In one embodiment, the filter may establish access restrictions for each tag and the corresponding external data. In block 655, tag data is aggregated into a uniform display. The aggregation of the data may be based on the filtering. The aggregated tag data is provided for the VRI in block 660.

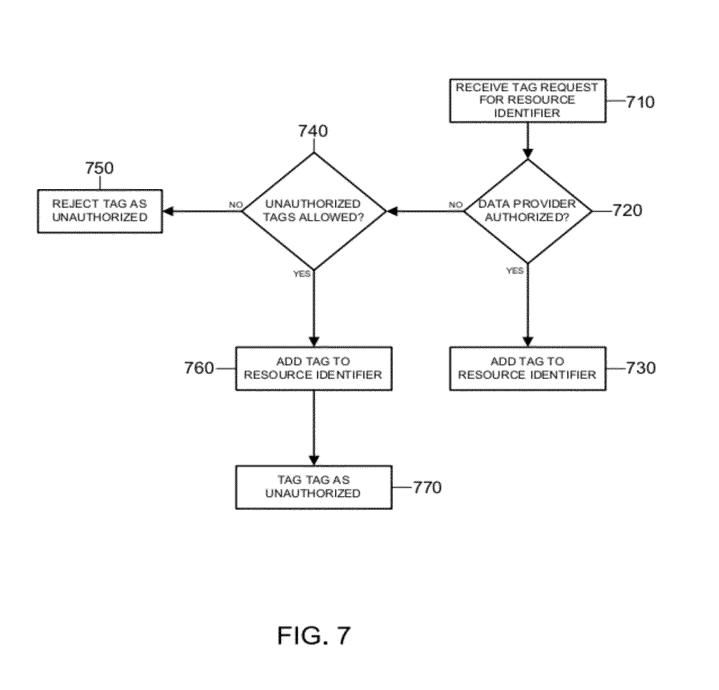

FIG. 7 is a flowchart illustrating the operations of writing a tag to a resource identifier in the systems of FIG. 2 and FIG. 3, or other resource tracking systems for loosely-coupled networks. The steps of FIG. 7 are described as being performed by the service provider server 340. However, the steps may be performed by the processor of the service provider server 340, or by any other hardware component of the service provider server 340. Alternatively the steps may be performed by an external hardware component.

FIG. 7 illustrates authorization and access requirements for writing tags. In block 710, a tag write request is received for a particular VRI. In block 720, a determination is made as to whether the data provider is authorized. The determination may be made as to whether the data provider is authorized for the VRI and/or whether the data provider is authorized for that particular tag. If the data provider is authorized, the tag is included as part of the tag cloud for that VRI in block 730. If the data provider is not authorized, then a determination is made as to whether unauthorized tags are allowed for that VRI in block 740. If unauthorized tags are not allowed, then the tag write request is rejected as unauthorized in block 750. If unauthorized tags are allowed, then the tag is added to the VRI in block 760. Although, the tag is included as part of the tag cloud for the VRI, the tag may be tagged as unauthorized in block 770.

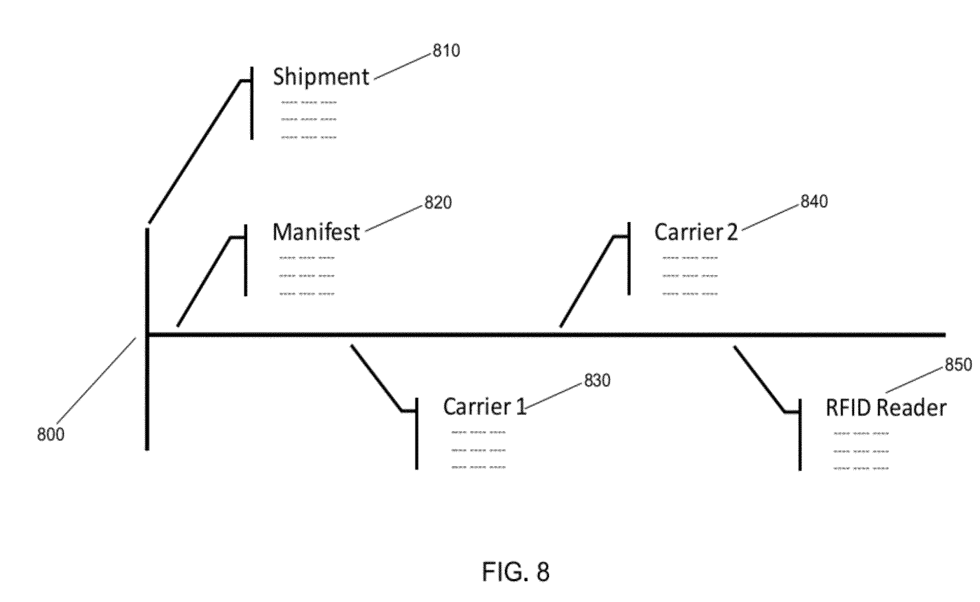

FIG. 8 is an illustration of exemplary tag associations for a resource identifier in the systems of FIG. 2 and FIG. 3, or resource tracking systems for loosely-coupled networks. In particular, a timeline 800 for a particular tracking session may include multiple locations, entities, and tags. For example, the shipment 810 and manifest 820 may be initial associations on the timeline. There may be several tags associated with both shipment 810 and manifest 820 that are associated with the VRI for the particular tracking session. Likewise, there may be tags from multiple carriers 830, 840 during the tracking for the VRI. In one embodiment, the tags that are automatically associated with the VRI may be generated by a RFID reader 850 that reads information about the shipment and automatically uploads information that is tagged to the VRI.

FIG. 10 is an illustration of a general computer system that may be used in the systems of FIG. 2 and FIG. 3, or other resource tracking systems for loosely-coupled networks. FIG. 10 illustrates a general computer system 1000, which may represent a service provider server 340, the computing devices 320A-N, the data provider servers 310A-B, the sensors 335, or any of the other computing devices referenced herein. The computer system 1000 may include a set of instructions 1024 that may be executed to cause the computer system 1000 to perform any one or more of the methods or computer based functions disclosed herein. The computer system 1000 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 1000 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 1024 (sequential or otherwise) that specify actions to be taken by that machine In a particular embodiment, the computer system 1000 may be implemented using electronic devices that provide voice, video or data communication. Further, while a single computer system 1000 may be illustrated, the term “system” shall also be taken to include any collection of systems or sub-systems that individually or jointly execute a set, or multiple sets, of instructions to perform one or more computer functions.

As illustrated in FIG. 10, the computer system 1000 may include a processor 1002, such as, a central processing unit (CPU), a graphics processing unit (GPU), or both. The processor 1002 may be a component in a variety of systems. For example, the processor 1002 may be part of a standard personal computer or a workstation. The processor 1002 may be one or more general processors, digital signal processors, application specific integrated circuits, field programmable gate arrays, servers, networks, digital circuits, analog circuits, combinations thereof, or other now known or later developed devices for analyzing and processing data. The processor 1002 may implement a software program, such as code generated manually (i.e., programmed).

The computer system 1000 may include a memory 1004 that can communicate via a bus 1008. The memory 1004 may be a main memory, a static memory, or a dynamic memory. The memory 1004 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 1004 may include a cache or random access memory for the processor 1002. Alternatively or in addition, the memory 1004 may be separate from the processor 1002, such as a cache memory of a processor, the system memory, or other memory. The memory 1004 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 1004 may be operable to store instructions 1024 executable by the processor 1002. The functions, acts or tasks illustrated in the figures or described herein may be performed by the programmed processor 1002 executing the instructions 1024 stored in the memory 1004. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 1000 may further include a display 1014, such as a liquid crystal display (LCD), an organic light emitting diode (OLED), a flat panel display, a solid state display, a cathode ray tube (CRT), a projector, a printer or other now known or later developed display device for outputting determined information. The display 1014 may act as an interface for the user to see the functioning of the processor 1002, or specifically as an interface with the software stored in the memory 1004 or in the drive unit 1006.

Additionally, the computer system 1000 may include an input device 1012 configured to allow a user to interact with any of the components of system 1000. The input device 1012 may be a number pad, a keyboard, or a cursor control device, such as a mouse, or a joystick, touch screen display, remote control or any other device operative to interact with the system 1000.

The computer system 1000 may also include a disk or optical drive unit 1006. The disk drive unit 1006 may include a computer-readable medium 1022 in which one or more sets of instructions 1024, e.g. software, can be embedded. Further, the instructions 1024 may perform one or more of the methods or logic as described herein. The instructions 1024 may reside completely, or at least partially, within the memory 1004 and/or within the processor 1002 during execution by the computer system 1000. The memory 1004 and the processor 1002 also may include computer-readable media as discussed above.

The present disclosure contemplates a computer-readable medium 1022 that includes instructions 1024 or receives and executes instructions 1024 responsive to a propagated signal; so that a device connected to a network 330 may communicate voice, video, audio, images or any other data over the network 330. Further, the instructions 1024 may be transmitted or received over the network 330 via a communication interface 1018. The communication interface 1018 may be a part of the processor 1002 or may be a separate component. The communication interface 1018 may be created in software or may be a physical connection in hardware. The communication interface 1018 may be configured to connect with a network 330, external media, the display 1014, or any other components in system 1000, or combinations thereof. The connection with the network 330 may be a physical connection, such as a wired Ethernet connection or may be established wirelessly as discussed below. Likewise, the additional connections with other components of the system 1000 may be physical connections or may be established wirelessly. In the case of a service provider server 240, the service provider server 240 may communicate with users 120A-N through the communication interface 1018.

The network 330 may include wired networks, wireless networks, or combinations thereof. The wireless network may be a cellular telephone network, an 802.11, 802.16, 802.20, or WiMax network. Further, the network 330 may be a public network, such as the Internet, a private network, such as an intranet, or combinations thereof, and may utilize a variety of networking protocols now available or later developed including, but not limited to TCP/IP based networking protocols.

The computer-readable medium 1022 may be a single medium, or the computer-readable medium 1022 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 1022 may include a solid-state memory such as a memory card or other package that houses one or more non-volatile read-only memories. The computer-readable medium 1022 also may be a random access memory or other volatile re-writable memory. Additionally, the computer-readable medium 1022 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A method comprising:
identifying a physical item at an origin of a supply chain;
assigning a substantially unique identifier to the physical item and storing the substantially unique identifier in a database;
receiving a discrete data item associated with the physical item;
associating the received discrete data item with the substantially unique identifier in the database;
receiving additional discrete data items associated with the physical item throughout the supply chain; and
providing access to the discrete data item and the additional discrete data items over a network.

2. The method of claim 1 wherein the discrete data item comprises a tag that is tagged with the substantially unique identifier in the database.

3. The method of claim 2 wherein the providing access to the discrete data item and the additional discrete data items over a network comprises generating a tag cloud that comprises tags from throughout the supply chain.

4. A system for tracking a physical item transported from a geographic origin to a geographic destination different therefrom via a mode of transportation, the system comprising:
an identifier allocator operative to generate a substantially unique identifier for the item responsive to a request therefore, the substantially unique identifier being different from another substantially unique identifier generated for another physical item different from the physical item;
a database operative to store the generated substantially unique identifier and further operative to subsequently receive and store, in association therewith, an arbitrarily created plurality of data items unknown to the database prior to the receipt thereof; and
a data item receiver operative to receive an arbitrarily created data item associated with the substantially unique identifier and store the received arbitrarily created data item in the database in association therewith.

5. The system of claim 4 wherein the data items comprises tags that are associated with the generated substantially unique identifier.

6. The system of claim 4 wherein the data item may comprise a link to another database.

7. The system of claim 4 wherein the data item may comprises an indication of the sender of the physical item, the manufacturer of the physical item, the transporter of the physical item, the recipient of the physical item, an identity of the sender of the data item.

8. The system of claim 4 wherein the data item is automatically generated.

9. The system of claim 8 wherein the data item comprises a global positioning system (GPS) signal or a RFID signal.

10. The system of claim 4 wherein the plurality of data items comprises a tag cloud.

11. The system of claim 4 further comprising a data item receiver operative to augment one or more characteristics to the data item.

12. The system of claim 11 wherein the one or more characteristics may comprise the date of receipt of the data item, time of receipt of the data item, origin of the data item, or combinations thereof, frequency of access, number of duplicate data items, access/authentication control.

13. The system of claim 4 further comprising a query processor operable to receive a request for information from the database, the request comprising the substantially unique identifier, a data item or combination thereof, and provide the plurality of data items, the identifier or a combination thereof, responsive to the request.

14. The system of claim 13 further comprising an analytical processor, a correlation processor, and an authentication processor.

15. The system of claim 4 wherein the origin and destination comprise at least a portion of a supply chain.

16. The system of claim 15 wherein the supply chain further comprises a plurality of intermediate origins and destinations.

17. The system of claim 4 wherein the physical item comprises an item indivisibly transported from the origin to the destination.

18. The system of claim 4 wherein the physical item may comprise a plurality of sub-items received from a prior origin and collected together at the origin or separated at the destination for individual transportation to one or more subsequent destinations.

19. The system of claim 4 wherein the substantially unique identifier is associated with an item identifier affixed to the item.

20. The system of claim 19 wherein the item identifier comprises one or more of a universal product code (UPC), proprietary tracking code, serial number, or VIN number.
